(19) United States
(12) Patent Application Publication
(10) Pub. No.: US 2006/0290231 A1
(43) Pub. Date: Dec. 28, 2006

(54) Small generator with collective multiple magnetic poles (2)

(76) Inventors: Yi-Yin Lin, Daya Township (TW); Hubert Chen, Daya Township (TW); Kuei-Tang Liao, Daya Township (TW)

Correspondence Address: TROXELL LAW OFFICE PLLC, SUITE 1404, 5205 LEESBURG PIKE, FALLS CHURCH, VA, 22041, US

(21) Appl. No.: 11/158,053

(22) Filed: Jun. 22, 2005

(51) Int. Cl. H02K 3/04; H02K 1/12

(52) U.S. Cl. 310/254; 310/208

(57) ABSTRACT

A small generator with collective multiple magnetic poles includes a magnet member, multiple magnetic poles arranged in an annular shape and facing to the magnet member, a iron core having its circumference connected with the multiple magnetic poles as integral, and multiple sheet-shaped coils respectively fitted on the magnetic poles. When the magnet member is rotated around the magnetic poles, the coils may generate electric current.

### BACKGROUND OF THE INVENTION

1. Field of the Invention

This invention relates to a small generator with collective multiple poles, particularly to one applied to a wheel hub of a bicycle.

2. Description of the Prior Art

A conventional small generator, especially applied to a wheel hub of a bicycle, is mostly a generator with nail-type magnetic poles, including a cylindrical member made of permanent magnet as a rotor, which a hug shell of a bicycle wheel is generally used for, and two stator yokes to match with the cylindrical member. The stator yokes have a round disc and multiple nail-shaped magnetic poles fitted around an outer circumference of the round disc, with the two stator yokes positioned abutting with each other by the magnetic poles. In the cylindrical member is an iron core fixed on a hub shaft for the magnetic flux of the magnetic poles to communicate and for magnetic lines of force to pass through. Further, a sheet-shaped coil wound on a coil frame is fixed, so the hub shell and the permanent magnet together function as an outer rotor, and the two stator yokes, the iron core, the coil frame, the coil and the hub shaft together function as the inner stator. Therefore, when the hub shell of the outer rotor is rotated by the spokes of a front or a rear wheel of a bicycle, the magnetic lines of force of the permanent magnet is transmitted from the nail-shaped magnetic poles on the inner stator yoke to the nail-shaped magnetic poles of the outer stator yoke via the iron core, so alternate magnetic lines of force of different directions may be generated on the iron core, and the coil on the coil frame may generate alternate current (AC) to be supplied to electronic appliances on the bicycle.

However, the sheet-shaped coil of the conventional small generator described above cannot be made automatically by mechanical process, necessary to be made manually, resulting in slow manufacture and high cost. Moreover, the magnetic wire required for the sheet-shaped coil is of large amount, in addition to the insufficient power generated by the conventional generator.

### SUMMARY OF THE INVENTION

This invention has been devised to offer a small generator with collective multiple poles applicable to a wheel hub of a bicycle.

The feature of the invention is a magnet member, collective multiple magnetic poles arranged in an annular shape and facing to the magnet member, an annular iron core for fitting the collective multiple magnetic poles on its circumference. Then the magnetic flux of the magnetic poles can communicate with the iron core, which then lets the magnetic lines of force to pass through. Further, a sheet-shaped coil is fitted on each magnetic pole, so when the magnet member is rotated around the magnetic poles on the iron core, the coils will generate alternate current, and that means the generator generates electricity.

As the coils can be made in advance quickly by mechanical process, unnecessary to be made manually, in addition to the less magnetic wire required for them so to save coil material cost. Moreover, electricity amount generated by the generator is larger than that by the conventional ones.

### BRIEF DESCRIPTION OF DRAWINGS

This invention will be better understood by referring to the accompanying drawings, wherein:

FIG. 1 is a cross-sectional view of a first embodiment of a small generator with collective multiple poles in the present invention, applied to a hub of a bicycle;

FIG. 2 is a partial exploded perspective view of the first embodiment of a small generator in the present invention;

FIG. 3 is a partial perspective view of the first embodiment of a small generator in the present invention;

FIG. 4 is a cross-sectional view of the first embodiment of a small generator in the present invention;

FIG. 5 is a magnified perspective view of a sheet-shaped coil in a small generator in the present invention;

FIG. 6 is a cross-sectional view of a third embodiment of a small generator with collective multiple magnetic poles in the present invention, applied to a hub of a bicycle;

FIG. 7 is a partial exploded perspective view of the third embodiment of a small generator in the present invention;

FIG. 8 is a side cross-sectional view of the third embodiment of a small generator in the present invention; and,

FIG. 9 is a cross-sectional view of a fourth embodiment of a small generator in the present invention, applied to a hub of a bicycle.

### DETAILED DESCRIPTION OF THE PREFERRED EMBODIMENTS

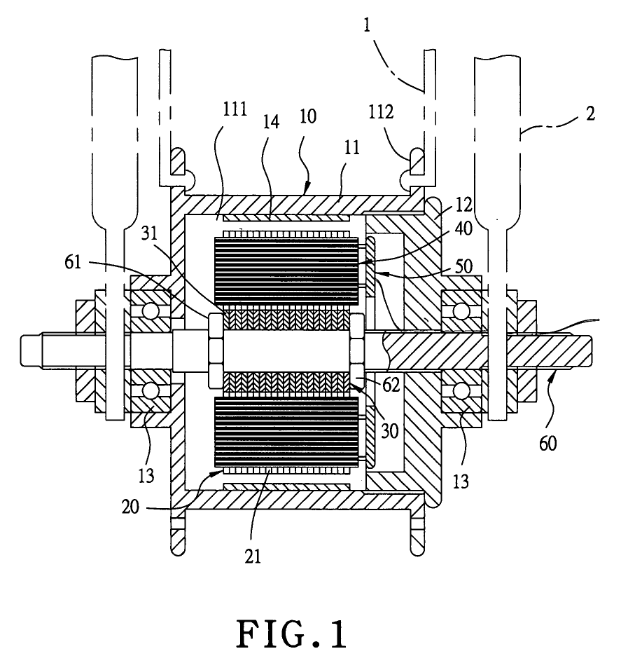

A first embodiment of a small generator with collective multiple magnetic poles is applied to a hub of a front or a rear wheel of a bicycle as shown in FIG. 1, and the hub includes a hub shell 10, a hub shaft 60 penetrating the hub shell 10 and two bearings 13 fixed at two opposite sides of the hub shell 10. Then plural spokes 1 of a front wheel or a rear wheel are fixed with the hub shell 10, and the fork 2 of the front or the rear wheel is fixed with the two ends of the hub shaft 60. Then when the hub shell 10 is rotated by the spokes 1, then the small generator will generate electric power, which is then to be supplied to a front light and a tail light of a bicycle.

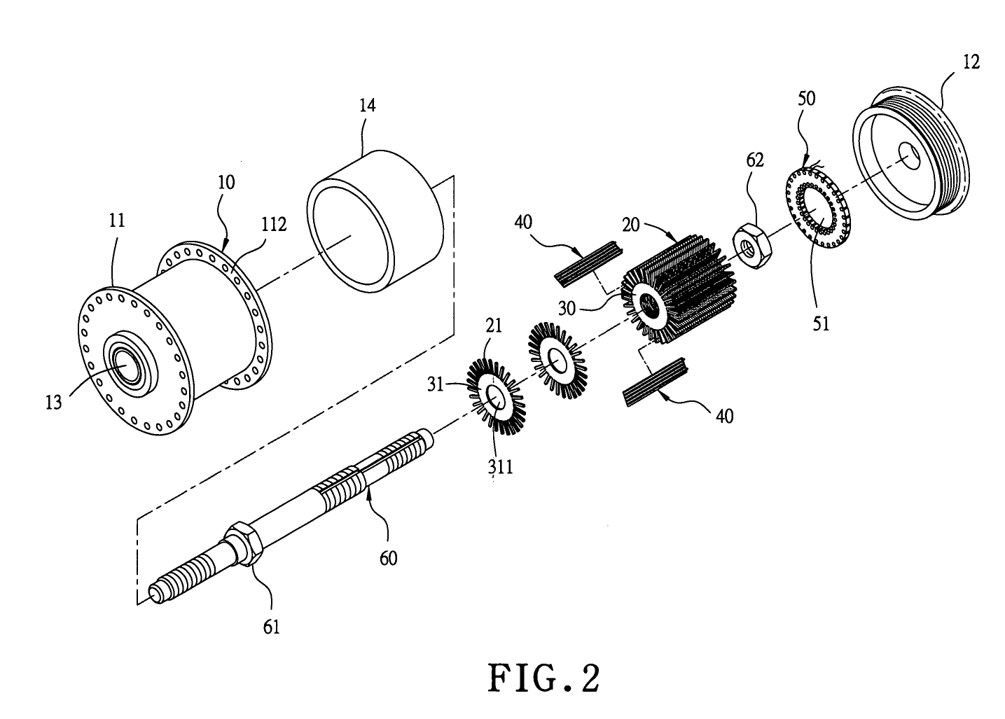

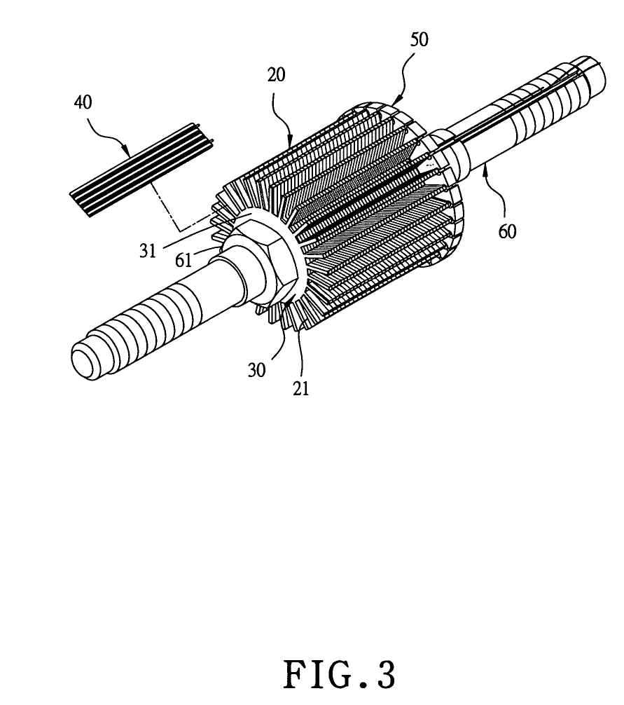

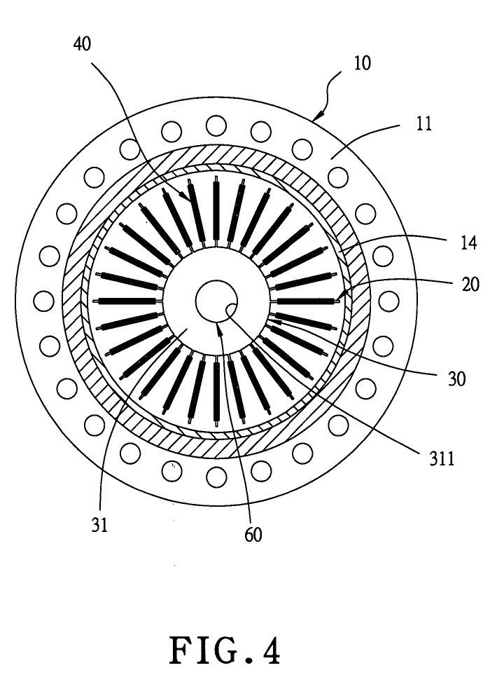

The first embodiment of a small generator applied to the hub of a bicycle, as shown in FIGS. 2, 3 and 4, includes an outer rotor and an inner stator. The outer rotor is a cylindrical body constituted of the hub shell 10, and the stator is constituted of multiple magnetic poles 20, an iron core 30, multiple sheet-shaped coils 40, a wire connecting PC board 50 and the hub shaft 60.

The hub shell 10 is composed of a first body 11 and a second body 12, and the first body 11 has an interior hollow 111 and the second body 12 fits firmly on the opening of the interior hollow 111. The first and the second body 11 and 12 are respectively fixed on the hub shaft 60 through the two bearings 13, so the hub shell 10 can rotate freely with the hub shaft 60 as a pivot. The first body 11 further has two annular flanges 112 on an outer circumference at two opposite sides, and the spokes 1 are connected firmly with the flanges 112. Then the hub shell 10 can be rotated by the spokes 1. Then a magnet member 14 is fixed on an inner annular wall defining the interior hollow 111 of the first body 11, consisting of four pieces of permanent magnet with the N poles and the S poles alternately arranged to face each other for forming a magnetic field, and there are totally 28 magnetic poles in the magnet member 14.

The multiple magnetic poles 20 are arranged to spaced apart equidistantly around the axial line of the hub shell 10 and each magnetic pole 20 faces to each pole of the magnet 14. The magnetic poles 20 in this embodiment have respectively an I-shaped cross-section, and each magnetic pole 20 is composed of plural thin magnet sheets 21 superposed closely together.

The iron core 30 is composed of a plurality of thin annular iron sheets 31 with a center hole 311 superposed closely on one another, and each thin annular iron sheet 31 is formed integral with each thin magnetic pole sheet 21 at the outer circumferential edge. So each magnetic pole 20 is also superposed in the same way as the iron core 30 is. Thus the iron core 30 communicates with the magnetic flux of each magnetic pole 20 to let the magnetic lines of force to pass through.

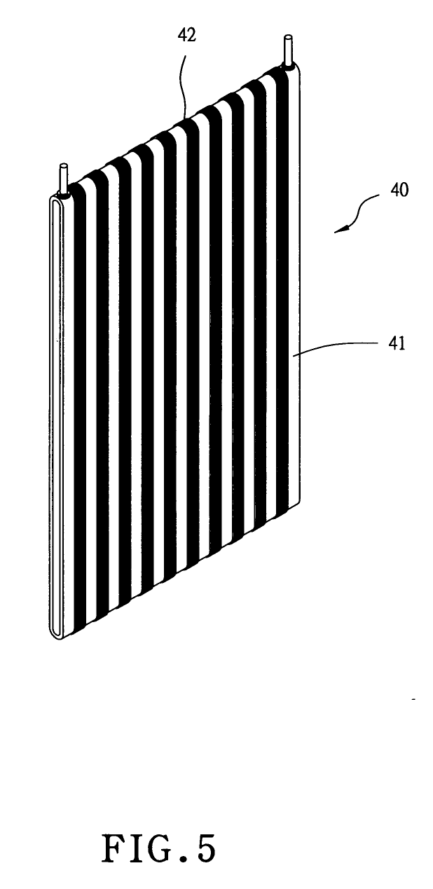

The sheet-shaped coils 40, as shown in FIG. 5, is made of a film circuit board 41 printed directly with a coil circuit 42 by mechanical process in this embodiment. And each sheet-shaped coil 40 is fitted around each magnetic pole 20. Nevertheless, the sheet-shaped coils 40 are also possible to be made by winding by mechanical process.

The wire-connecting PC board 50 is circular, located at one side of the multiple magnetic poles 20, having a center hole 51 and its outer circumference connected with two ends of each sheet-shaped coil 40 for transmitting electricity generated on the coils 40.

The hub shaft 60 penetrates the center of the first and the second body 11 and 12, and further passes through the center hole 311 of the iron core 30, and the center hole 51 of the PC board 51. The hub shaft 60 further has a stage of a projecting member 61 at a proper location for the outer wall of the iron core 30 to rest against, and a nut 62 at the other side of the iron core 30 for tightening the side wall so as to fix tightly the magnetic poles 20, the iron core 30, the sheet-shaped coils 40 and the PC board 50 on the hub shaft 60.

In using, as shown in FIG. 1, when a user steps the pedals to rotate the wheels of a bicycle, the spokes 1 are also rotated to force the outer rotor constituted of the hub shell 10 and the magnet member 14 rotate around the stator constituted of the magnetic poles 20, the iron core 30, the sheet-shaped coils 40, the PC board 50 and the hub shaft 60. Then magnetization incessantly occurs between the magnet member 14 and each magnetic pole 20, which then generates alternate magnetic line of force in the radial direction through the iron core 30, so the sheet-shaped coils 40 may generate alternate current. Then the electricity generated is transmitted to the PC board 50 for properly treated and to be supplied to electric appliances on the bicycle.

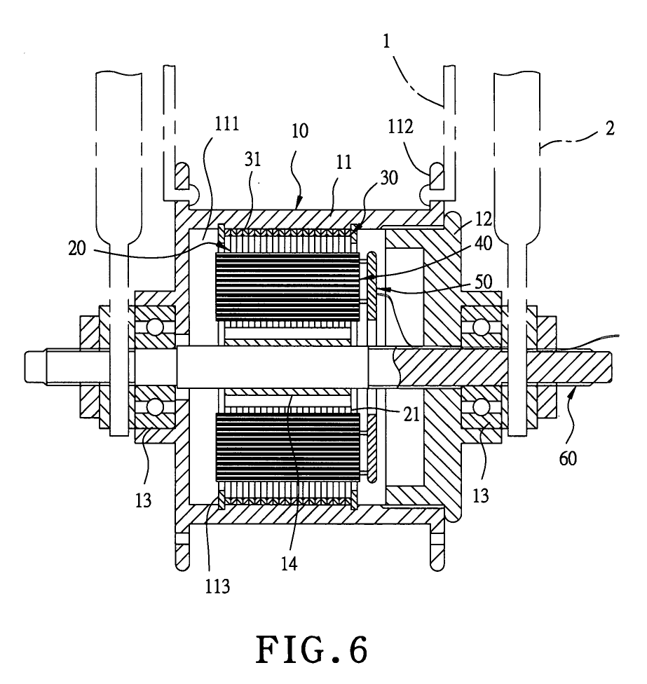

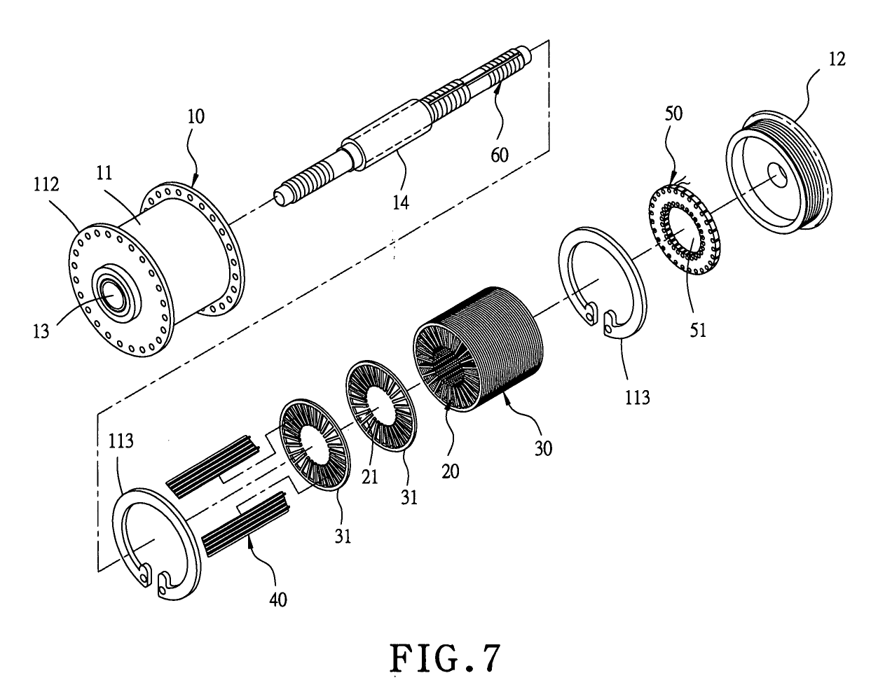

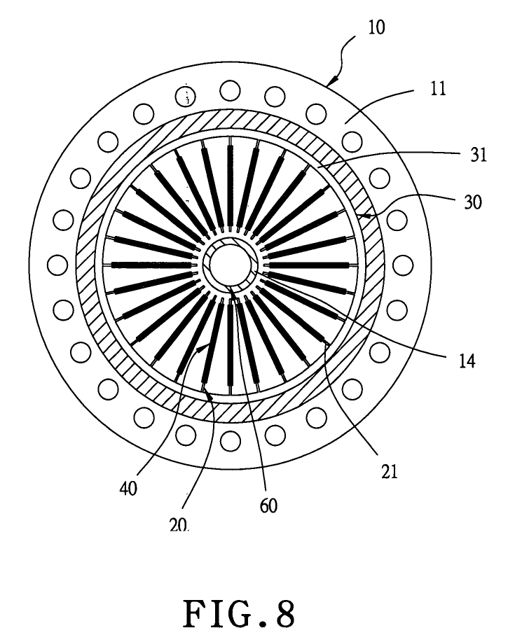

Next, FIGS. 6, 7 and 8 show a second embodiment of a small generator with collective multiple magnetic poles in the invention, and the main difference from the first embodiment is that the stator instead of the rotor is fixed with the hub shell 10. In other words, the location of the stator and the rotor is exchanged. So the iron core 30 is fixed on an inner wall of the first body 11 of the hub shell 10, and the magnetic poles 20 are formed around the inner circumference of the iron core 30. Then two C-shaped locking washers 113 are fixed at two opposite sides of the first body 11, locking the iron core 30 in place. Then the magnet member 14 is fixed around the hub shaft 60 to face to the magnetic poles 20. So the iron core 30, the magnetic poles 20, the sheet-shaped coils 40 and the hub shell 10 constitute the outer rotor, and the magnet member 14 and the hub shaft 60 constitute the inner stator. So when the outer rotor rotates around the inner stator, the magnetic poles 20 receives the magnetic lines of force of the magnet member 14, generating alternate magnetic lines of force thereon, so the sheet-shaped coils 40 generate alternate current.

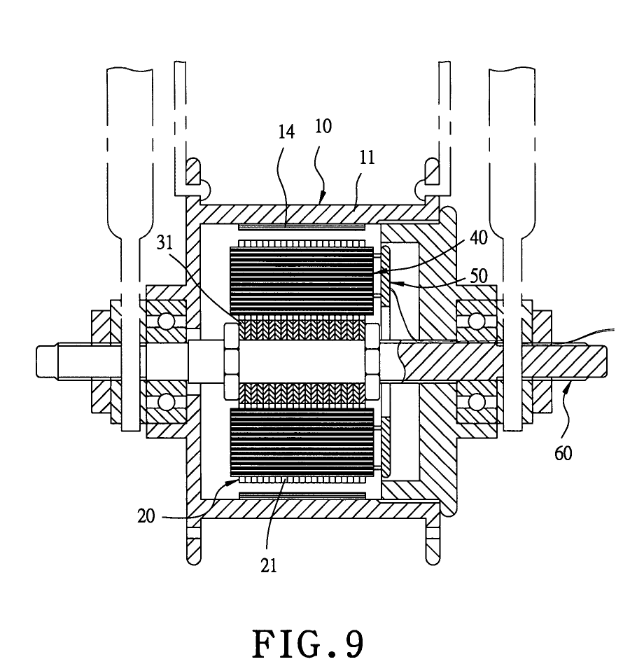

Next, another embodiment of the magnet member 14 in the invention is shown in FIG. 9, and an electromagnet possible to generate magnetization is used instead of the permanent magnet for the magnet member 14. So when the electromagnet 14 is powered on, each magnetic pole of the outer rotor rotated around the stator by the wheel of a bicycle receives the magnetic lines of force from the electromagnet 14, and accordingly generates alternate magnetic lines of force so that the sheet-shaped coils 40 may generate alternate current.

When the electromagnet 14 is under the powered-off condition, there is no magnetization occurring between the electromagnet 14 and the sheet-shaped coils 40 even if the outer rotor should be rotated. So the user riding on the bicycle may not receive interference of magnetic attraction of the generator, and does not need more force for stepping the pedals of the bicycle for riding.

The invention has the following advantages as can be understood from the foresaid description.
1. The sheet-shaped coils 40 can be made in advance by mechanical process with fastness, winding magnetic wire or by printing a coil circuit 42 on a film circuit board 41, needing no manual work for winding, saving time and cost.
2. As the sheet-shaped coils are fitted on the magnetic poles 20, the magnetic wire required for the coils 40 can be reduced largely, possible to save much of the material cost.
3. After practical use and testing, the generator in the invention has been proved to generate more electricity amount than the conventional ones do.
4. The outer rotor and the inner stator of the generator in the invention can be exchanged in their locations for generating electricity, so there are various structures optional for the generator.
5. A permanent magnet or an electromagnet can be used for the magnet member 14, and if the electromagnet is used for it, between the electromagnet 14 not powered and the sheet-shaped coils 40 may not occur magnetization, so even if the outer rotor should be rotated, it could not receive magnetic force from the inner stator so that a user stepping on the pedals in riding a bicycle may not need more foot force for stepping, as there is no interference of magnetic attraction by the generator.

While the preferred embodiments of the invention have been described above, it will be recognized and understood that various modifications may be made therein and the appended claims are intended to cover all such modifications that may fall within the spirit and scope of the invention.

What is claimed is:

1. A small generator with collective multiple magnetic poles, said small generator comprising:
A magnet member;
Multiple magnetic poles arranged in an annular shape and facing to said magnet with a same gap;
An iron core shaped annular and formed integral with said multiple magnetic poles for magnetic flux of each said magnetic pole to communicate with to let magnetic lines of force to pass through; and,
Multiple sheet-shaped coils respectively fitted on each said magnetic poles.

2. The small generator with collective multiple magnetic poles as claimed in claim 1, wherein further a cylindrical member is provided in said generator, said magnet member is fixed on an inner wall of said cylindrical member, and said magnetic poles are formed integral with an outer circumference of said iron core and face to said magnet member.

3. The small generator with collective multiple magnetic poles as claimed in claim 1, wherein further a cylindrical member is provided in said generator, said iron core is fixed on an inner wall of said cylindrical member, said magnetic poles are formed integral with an inner circumference of said iron core and face to said magnet member.

4. The small generator with collective multiple magnetic poles as claimed in claim 2, wherein said cylindrical member provided with said magnet member therein constitutes an outer rotor, said magnetic poles, said iron core, and said sheet-shaped coils together constitute an inner stator, and said stator is provided in said cylindrical member on a same shaft of said cylindrical member.

5. The small generator with collective multiple magnetic poles as claimed in claim 4, wherein said inner stator is fixed on a hub shaft of a wheel, and said outer rotor is connected with a rotating component of said wheel.

6. The small generator with collective multiple magnetic poles as claimed in claim 3, wherein said iron core, said magnetic poles and said sheet-shaped coils fixed in said cylindrical member constitute an outer rotor, and said magnet member constitutes an inner stator, fixed on a same shaft of said cylindrical member and located in a hollow space surrounded by said multiple magnetic poles,

7. The small generator with collective multiple magnetic poles as claimed in claim 1, wherein said iron core is composed of a plurality of annular thin iron sheets superposed closely on one another.

8. The small generator with collective multiple magnetic poles as claimed in claim 1, wherein said magnetic poles respectively have an I-shaped cross-section.

9. The small generator with collective multiple magnetic poles as claimed in claim 1, wherein said sheet-shaped coils respectively have two ends of its wire connected with a wire-connecting PC board, and said wire-connecting PC board is located at one side of said multiple magnetic poles.

10. The small generator with collective multiple magnetic poles as claimed in claim 1, wherein said sheet-shaped coils are respectively made by printing a coil circuit on a film circuit board.

11. The small generator with collective multiple magnetic poles as claimed in claim 1, wherein said magnet member is a permanent magnet.

12. The small generator with collective multiple magnetic poles as claimed in claim 1, wherein said magnet member is an electromagnet.
